(19) United States
(12) Patent Application Publication
(10) Pub. No.: US 2009/0202397 A1
(43) Pub. Date: Aug. 13, 2009

(54) SYSTEM AND METHOD FOR DELIVERING AND CONDITIONING AIR TO REDUCE VOLATILE ORGANIC COMPOUNDS AND OZONE

(75) Inventors: Andrew J. Parker, Novato, CA (US); Igor Y. Botvinnik, Novato, CA (US); Charles E. Taylor, Punta Gorda, FL (US)

Correspondence Address: BELL, BOYD & LLOYD LLP, P.O. BOX 1135, CHICAGO, IL, 60690, US

(73) Assignee: SHARPER IMAGE CORPORATION, San Francisco, CA (US)

(21) Appl. No.: 11/996,258

(22) PCT Filed: Jul. 24, 2006
(86) PCT No.: PCT/US06/28656

§ 371 Date: Nov. 17, 2008

Related U.S. Application Data
(60) Provisional application No. 60/701,686, filed on Jul. 22, 2005.
(60) Provisional application No. 60/701,772, filed on Jul. 22, 2005.

(51) Int. Cl. B01D 53/66; B01D 53/34

(52) U.S. Cl. 422/121; 422/120

(57) ABSTRACT

Conditioning matrices for removing pollutants from air streams of electro-static and electromechanical devices are disclosed. The conditioning matrices can be coated with a reactive material that interacts with the airflow. The conditioning matrices can be positioned in the air stream and catalyze reactions of pollutants into nonpolluting compounds.

### BACKGROUND

Volatile organic compounds are petroleum-based chemicals which are often found at elevated levels in many houses. Thousands of possible volatile organic compounds outgas from common household products such as, for example, synthetic fragrances (as found in soaps, candles, air fresheners, incense and potpourri), paint, carpet, furnishings, glues, plastics, pressed wood products (such as plywood and particle board), and even fresh flowers. Formaldehyde is one example of a volatile organic compound (VOC) that can be a particular problem in homes because it is found in many building materials such as caulks and adhesives, paint, furniture, etc. Formaldehyde is a desensitizing substance that lowers the ability to recognize or sense other potentially harmful chemicals. Prolonged exposure to formaldehyde often causes headaches, numbness or tingling of extremities, lightheadedness, inability to concentrate, anxiety, and depression. Outgassing can be diluted by improving air flow; however, where a source of formaldehyde or other volatile organic compound is organic matter such as mold, outgassing can be continuous and persistent. Volatile organic compounds that are outgassed as waste products of mold can be more dangerous to an individual's health than mold spores drifting through the air.

In addition to producing the unpleasant side effects discussed above, a VOC can produce noticeable and noxious odors. For example, the treatment processes for many municipal water sources utilize chlorine dioxide as a disinfectant. When a faucet is turned on and the water is running, the chlorine dioxide suspended within the water can diffuse into the air. The airborne chlorine dioxide, in turn, can combine with outgassed volatile organic compounds found in the ambient air to produce a noxious odor. These compounds often collect in enclosed areas such as, for example, laundry rooms, basements, bathrooms and closets that have little ventilation. The lack of ventilation often results in a concentration of these odor causing compounds. Furthermore, the potential for producing these noxious odors directly correlates with the level of a VOC within the home and the amount of chlorine dioxide diffused from the water. Thus, any reduction in the VOC level will result in a corresponding risk reduction for producing these noxious odors.

In an effort to increase air flow, dilute and possibly reduce exposure to volatile organic compounds many devices incorporating fans, impellers and electro-kinetic techniques have been developed. For example, as shown in FIG. 1A, a known air delivery system 100 includes a housing 102 having at least one air input 104 fluidly connected to at least one air output 106. Within the housing 102, a rotary or impeller fan 108 is arranged adjacent to a filter 110. The fan 108 and filter 110 are fluidly connected along the airflow path A-A. In particular, the fan 108 draws ambient air into the housing 102 through the air inlet 104. Once inside the housing 102, the ambient air is accelerated by the fan 108 and directed towards the filter 110. As the air moves along the airflow path A-A, the porous structure 112 of the filter 110 removes large airborne particles 114 suspended within the air. However, the porous structure 112 is unable to remove particles, compounds and chemicals such as volatile organic compounds and ozone which are small enough to pass through the filter pores. Consequently these volatile organic compounds and ozone remain in the airflow path A-A and the ambient air after exiting the housing 102 through the air outlet 106.

In an effort to remove, or at least reduce, the level of volatile organic compounds in airflow path A-A and ambient air, some air delivery systems replace the filter 110 with a high-efficiency particulate arrester (HEPA) filter and a carbon filter. The HEPA filter can collect significant amounts of large particulate matter (0.3 μm and above) and the carbon filter can absorb the volatile organic compounds and the associated unpleasant odors directly from the ambient air and the airflow path A-A. However, HEPA filters have limited effectiveness when attempting to collect particulate matter or airborne particles 114 smaller than 0.3 μm. Moreover, both HEPA and carbon filters eventually saturate and require replacement to prevent excess volatile organic compounds and odors from being dumped back into the ambient air and the airflow path A-A.

FIG. 1B illustrates another known air delivery system 100 that includes a known electro-kinetic air delivery system 120. Similar to the system shown in FIG. 1A, the electro-kinetic air delivery system 120 is supported within a housing 102 having at least one air inlet 104 fluidly connected at least on air output 106. The electro-kinetic air delivery system 120 includes at least one emitter array 122 spaced apart and opposing at least one collector array 124. The electro-kinetic air delivery system 120 further includes a power source 126 having positive and negative terminals 128, 130 electrically coupled or connected to the emitter array 122 and the collector array 124, respectively. A high voltage charge provided by the power source 126 charges the arrays 122, 124 which, in turn, ionize the ambient air and the airborne particles 114 within the housing 102.

The differences in electrical potential between the emitter array 122 and the collector array 124 encourages the ionized air to move along the airflow path A-A. Charged contaminants and airborne particulates 114 suspended within the ionized air are electrostatically attracted to the surface of the collector array 124. The electrostatic attraction between the particulates 114 and the collector array 124 remove the charged particulates 114 from the airflow path A-A. The high voltage charge provided by the power source 126 generates and releases ionized air which has been found to be beneficial in small quantities in eliminating many of the VOC and noxious odors. However, it has been theorized that excessive amounts of ionized air can be undesirable. Thus, it is often necessary to reduce the intensity and frequency of the high voltage pulses to decrease ionized air production. This reduction often results in a decrease in the overall airflow and efficiency of the electro-kinetic air delivery system 120.

Another common pollutant is ozone. The bulk of ground level ozone is an invisible gas that forms when pollutants emitted by cars, power plants, industrial boilers, refineries, chemical plants, household paints, stains and solvents and other sources react chemically in the presence of heat and sunlight. The presence of ground level ozone presents serious air quality problems in many parts of the United States, particularly in large cities. For humans and other animals, ozone can be harmful when it is inhaled in sufficient quantities to cause a number of respiratory effects. Ozone can trigger attacks and symptoms in individuals with pre-existing health conditions, such as asthma or other respiratory infections.

Weather plays a key role in ozone formation. The highest ozone levels are usually recorded in summer months when temperatures approach the high 80s and 90s and when the wind is stagnant or light.

It is recommended that when ozone levels are high, people at risk should take simple precautions:
a. Stay indoors as much as possible.
b. Limit outside activities to the early morning hours or after sunset since ozone levels tend to go down with the sun.
c. Refrain from exercising or working vigorously outdoors when levels are high.
d. Stay away from high traffic areas, and avoid exercising near these areas at all times.
e. Carpool or use public transportation to help reduce the amount of harmful emissions in the air that contribute to the production of ozone.
f. Avoid using gasoline-powered lawn equipment or other gasoline-powered tools.

However, these precautions are directed at avoiding areas where the levels of ozone are high. They do not alleviate the problem of ozone itself.

Accordingly, it may be desirable to provide an efficient and versatile air delivery system that can reduce volatile organic compounds and ozone emissions.

### SUMMARY

Illustrative examples of air delivery and conditioning systems configured to reduce ozone and volatile reactive compounds in the ambient air and along an airflow path are disclosed. In one example, an air delivery and conditioning system includes a housing having a substantially hollow interior that defines an air inlet fluidly connected to an air outlet. The housing carries at least one airflow generator positioned substantially adjacent to the air inlet and configured to create an airflow between the air inlet and the air outlet. The housing further supports a conditioning matrix positioned next to the air outlet along the airflow created by the at least one air flow generator, The conditioning matrix is coated with a reactive material that interact with the airflow between the air inlet and the air outlet to reduce ozone.

In an embodiment compositions for removing ozone from air are also disclosed. The ozone reduction compositions include a porous support structure which allows for the passage of air and has an ozone reactive surface. The support can be housed such that it can be attached to fans or other air moving devices such that as air moves, it passes by the reactive surface of the support where at least a portion of the ozone is removed.

Additional features and advantages are described herein, and will be apparent from, the following Detailed Description and the figures.

### BRIEF DESCRIPTION OF THE FIGURES

FIGS. 1A and 1B are schematics of representations of known air delivery systems.

FIG. 2A is a perspective view of one embodiment of an air delivery and conditioning system.

FIGS. 2B and 2C are representations of air delivery systems that include fan assemblies for air delivery.

FIG. 3 is another perspective view of the embodiment of an air delivery and conditioning system shown in FIG. 2A.

FIGS. 4A to 4H are top views of alternate embodiments of air delivery and conditioning systems.

FIG. 5 illustrates a perspective view of an exemplary embodiment of the ozone-reducing substrate.

FIG. 6 illustrates an exemplary embodiment of an ozone reducing substrate attached to a housing.

FIG. 7 illustrates an exemplary embodiment of an ozone reducing substrate structure attached to a housing.

FIG. 8 illustrates an exemplary embodiment of an air flow device to which an ozone reducing housing is attached to the protective covering for the air movement device.

### DETAILED DESCRIPTION

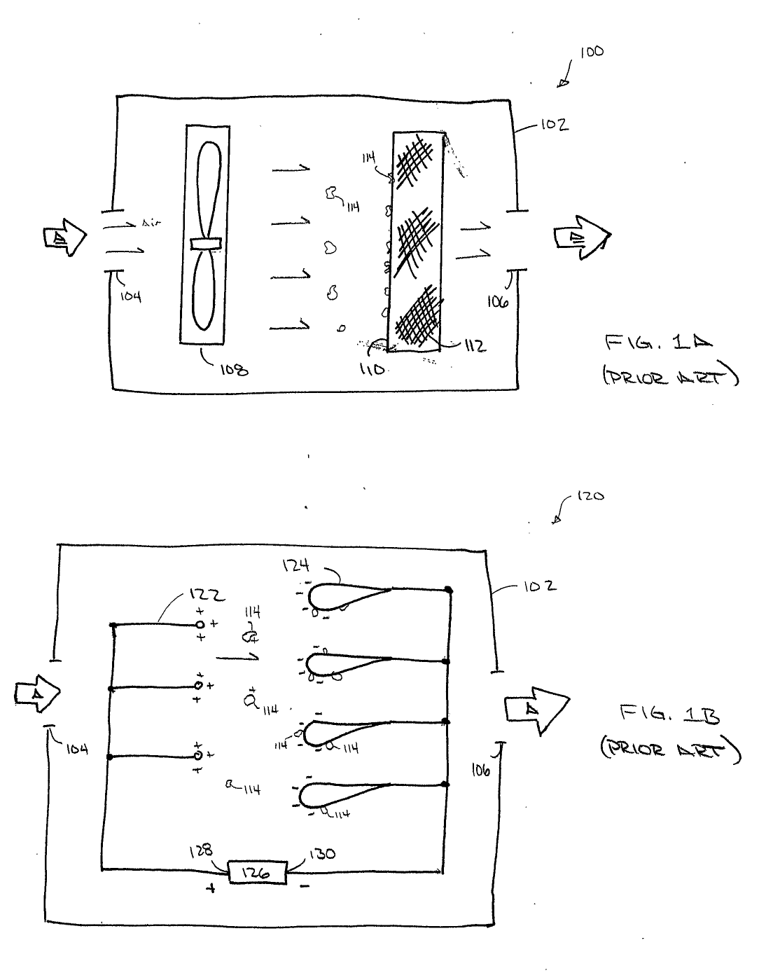

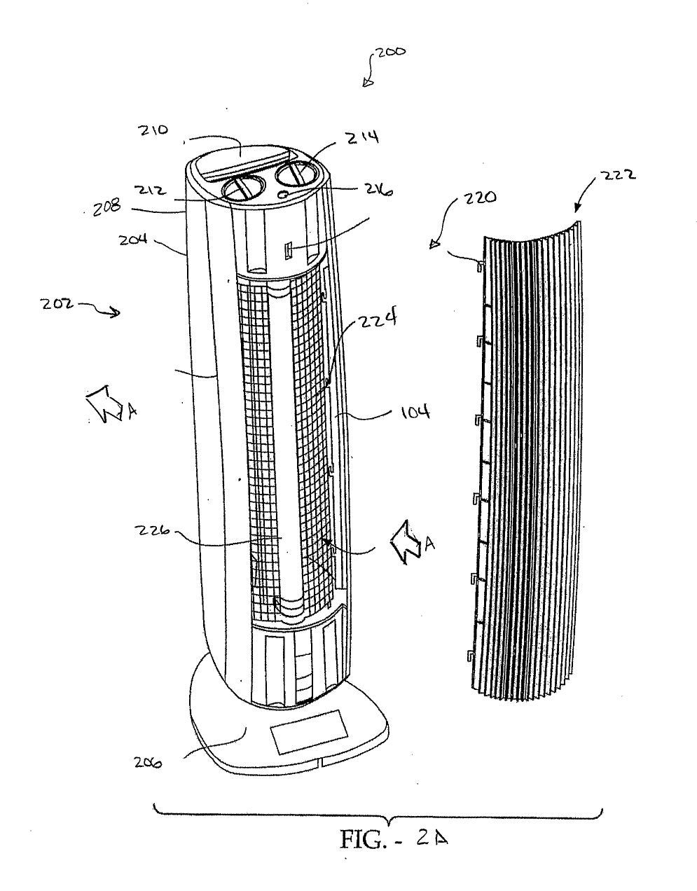

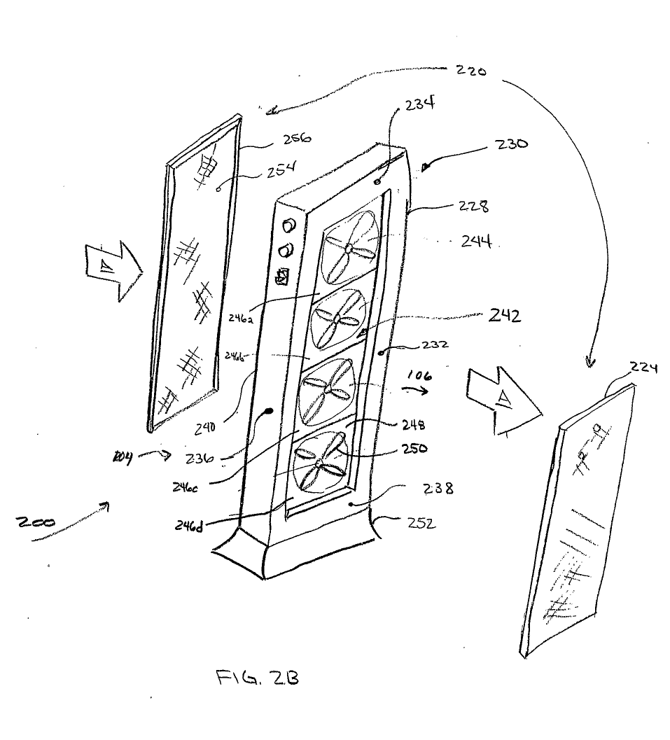

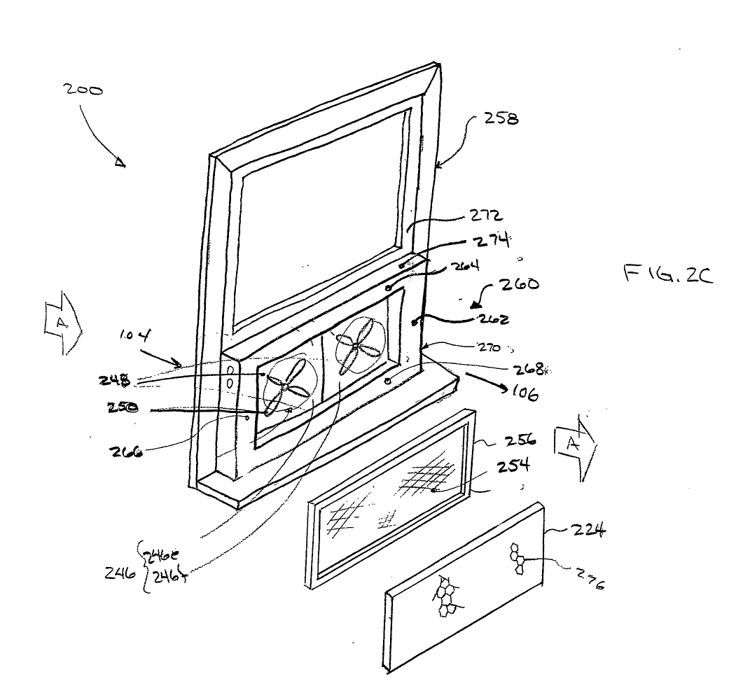

FIG. 2A illustrates one embodiment of an air delivery and conditioning system 200 that can support air flow generators such as, for example, the electro-kinetic and fan-based air delivery systems shown in FIGS. 1A and 1B. It will be understood that this system illustrates one embodiment of the air delivery system 200 which is constructed in accordance with the teachings of the present invention. This exemplary system 200 may include one or more filter screens, conditioning surfaces and conditioning matrices, arranged to reduce the presence of volatile organic compounds and ozone in the airflow path A-A and the ambient air. Moreover, it will be understood that the filter screens, conditioning surfaces and conditioning matrices may be arranged in the air delivery and conditioning system 200 along any point within the airflow path A-A defined between the air inlet 104 and the air outlet 106.

Returning to FIG. 2A, a housing 202 includes a tower portion 204 carried by a support base 206. The tower portion 204 is configured to support the air flow generators discussed and described in FIGS. 1A and 1B. In particular, either or both of the air delivery systems or air flow generators can be incorporated within the air delivery system 200 to achieve a desired air flow volume or to remove specific types and quantities of contaminants and chemicals from the airflow path A-A and the ambient air.

The housing 202 further includes a control cap 208 having an access panel 210, and controls 212, 214, 216. The access panel 210 can be a flip-up panel or a removable panel that allows access to the air flow generators supported within the housing 202. Specifically, a user may remove the access panel 210 to perform maintenance or service on, for example, the arrays 122, 124, the fan(s) 108 and one or more of the filter screens, conditioning surfaces and conditioning matrices discussed below. The controls 212, 214, 216 can be, for example, a speed control, a selector, and a power switch, respectively. The speed control 212 can control the operation of the fan(s) 108 or the arrays 122, 124 which, in turn, varies the volume and speed of air along the airflow path A-A. The selector 214 can be an option selector that controls the use of the fan-based system, the electro-kinetic air delivery system 120, and a conditioning system generally indicated by the reference numeral 220. The power switch 216 can engage the power source 126 or other potential source necessary to operate the fan-based air delivery system 100 and the electro-kinetic air delivery system 120.

The housing 202 supports the conditioning system 220 which includes a filter screen or grill 222, a conditioning matrix 224 and an activator lamp 226. In one embodiment, the filter screen 222 is a pre-screen filter that removes large particulates 114 from the ambient air before the air enters the housing via the air inlet 104. The filter screen 222 can be, for example, a passive fine wire mesh or an active metallic mesh coated with a reactive material such as titanium dioxide (TiO₂) that reacts with the volatile compounds in the ambient air. Similarly, the conditioning matrix 224 could be a passive or active mesh or a “honeycomb” filter arranged to remove unwanted particles and compounds from the ambient air. Often, the conditioning matrix 224 will be an active metallic mesh coated with a catalytic compound selected to react with any unwanted ozone or volatile organic compounds present in the ambient air. Depending on the type, coating and function of the conditioning matrix 224 and the filter screen 222, the activator lamp 226 may be employed to initiate the reaction between the catalytic coating and the unwanted ozone or VOC.

FIG. 2B illustrates another embodiment of the air delivery and conditioning system 200. The air delivery and conditioning system 200 of this exemplary embodiment is a fan-based air flow generator that includes an elongated housing 230 having support members 232, 234, 236, and 238 arranged to form a substantially rectangular frame 240. The frame 240 and more specifically, the support elements 232, 234, 236, and 238, cooperate to provide a rectangular interior 242 suitable for carrying a plurality of fan-based air delivery systems 244. In particular, the exemplary embodiment illustrated in FIG. 2B shows four fan units (individually indicated by the reference numerals 246a to 246d) stacked within the rectangular frame 240 and arranged to force the ambient air along the airflow path A-A. Each of the fan units 246 can be a “computer” type fan that includes a square frame 248 and a propeller 250.

It will be understood that by varying the dimensions of the support members 232, 234, 236, and 238, the corresponding rectangular interior of the frame 240 can be varied to support any desired number or configuration of the fan units 246. For example, the overall housing size can be reduced by removing two of the four fan assemblies 246 and decreasing the length of the support members 232 and 236 by half.

It will be understood that while the air delivery and conditioning system 200 shown in FIG. 2B is a vertically freestanding system supported by a base 252, many different system orientations are possible within the scope of this invention. For example, the base 252 can be arranged to engage the support member 236 and thereby align the frame 240 in a substantially horizontal manner. Moreover, the base 252 could be omitted entirely and the frame 240 could be mounted substantially adjacent to a wall.

As previously mentioned, the air delivery and conditioning system 200 supports the conditioning system 220 having one or more conditioning elements or matrices. The conditioning system 220 in this exemplary embodiment includes a fine wire mesh filter screen 254 stretched across a rigid or semi-rigid frame 256. The mesh of the filter screen 254 can be sized to remove dust large particular matter 114 that would otherwise gather and potentially clog the fan units 246.

The conditioning system 220 can further include a conditioning matrix 224. In one embodiment, the conditioning matrix 224 includes an active manganese oxide coating capable of reacting with and removing selected compounds and chemicals from the ambient air. In one embodiment, the conditioning matrix 224 is positioned adjacent to the air outlet 106. This arrangement of the conditioning matrix 224 allows for the reduction or removal of compounds or chemicals suspended within the ambient air traveling along the path airflow A-A as the air exits the housing 230 through the air outlet 106. While the housing 230 illustrated in FIG. 2B is a vertically elongated housing, it will be understood that in some instances the housing 230 could be manufactured to integrally include the conditioning matrix 224 and or the wire mesh filter screen 254.

FIG. 2C illustrates another embodiment of an air delivery and conditioning system 200 adapted for mounting within a window casement or sash 258. The system 200 includes a horizontal housing 260 including support members 262, 264, 266 and 268 arranged to form a rectangular frame 270. The frame 270 is sized to cooperate a movable window portion 272 supported within the sash 258. Similar to the frame 240 discussed above in connection with the embodiment shown in FIG. 2B, the rectangular interior of the frame 270 is sized to carry and support a pair of fan units 246 (uniquely identified as 246e and 246f). It will be understood that while two fan units 246 are shown in the illustrated embodiment, different configurations, sizes and types of fans can be integrated into the housing 260 in order to facilitate an airflow A-A that transports and conditions the ambient air.

To mount or secure the housing 260, the movable window portion 272 can be arranged in a full open position to allow the housing 260 to be rested within the sash 258. Upon proper alignment and positioning of the housing 260 within the sash 258, the movable window portion 272 can be shifted into an abutting relationship with a top surface 274 of the frame 270. Depending on the size and shape of the window and sash 258, it may be advantageous to use one or more spacer or filler members (not shown) between the frame 270 and the sash 270 to seal and support the housing 260 in a desired location.

In one embodiment, the housing 260 supports the fine wire mesh filter screen 254 and the conditioning matrix 224. As previously discussed the filter screen 254 can remove large particular matter from the ambient air and the airflow path A-A, and prevent insects or other pests from entering through the air inlet 104 of the system 200. The housing 270 can further support the conditioning matrix 224 to remove or reduce the presence of ozone or volatile organic compounds within the ambient air.

The conditioning system 220 and the associated filter screens 222, 254 and conditioning matrixes 224 can be affixed and incorporated into the air delivery and conditioning system 200 in various well-understood manners. Inclusion of filter screens 222, 254 and conditioning matrixes 224 allow for removal and reduction the volatile organic compounds (VOC) and/or the excess ozone (O₃) contained within the ambient air and transported along the airflow path A-A.

One technique for conditioning and removing pollutants or contaminants from an air flow is photocatalysis. Generally, photocatalysis utilizes a reactive material or catalyst and an ultraviolet (UV) radiation source or UV lamp 226 arranged to activate the catalyst. The activated catalyst, in turn, breaks down or oxidizes the hazardous chemicals such as VOC and O₃. For example, one such catalyst is microporous titania ceramic (titanium dioxide, TiO₂), a thin layer of which can be coated on a surface of the filter screen 222, 254, and the matrix 224. Titanium dioxide is a semi-conducting photocatalyst having a band gap energy of 3.2 eV. When titanium dioxide is irradiated with photons having wavelengths of less than 385 nanometers (nm), the band gap energy is exceeded and an electron is promoted from the valence band to the conduction band. The resultant electron-hole pair has a lifetime that enables its participation in chemical reactions. The UV lamp 226 (or a source of radiation outside of the UV spectrum having a wavelength less than 385 nm) can be used to activate the titania ceramic, which when illuminated can oxidize volatile organic compounds present in the ambient air and the airflow path A-A, breaking the compounds into water and carbon dioxide. In addition, irradiating the ambient air traveling within the airflow path A-A with ultraviolet light from the UV lamp 226 can substantially eliminate microorganisms within the airflow.

In one embodiment of the electro-kinetic air delivery system 120 described herein, an interstitial or driver electrode (not shown) can include a photocatalytic coating, or can be embedded or impregnated with photocatalytic material. Use of a photocatalytic coating can promote oxidation of air in close proximity to the interstitial or driver electrode array. In other embodiments, the walls of the housings 202, 230 and 260 can be embedded or impregnated with photocatalytic material, or the walls of the housing can include a photocatalytic coating. In the embodiments shown in FIG. 2A, the conditioning matrix 224 can be a “honeycomb” structure that is at least partially coated or embedded with a photocatalytic material positioned in the airflow A-A adjacent to the UV lamp 226.

It will be understood that the porous or “honeycomb” structures need not have a regular grid-like structure. For example, the porous structure can have a web-like structure, or a spiral structure. Further, in some other embodiments, where an airflow already exists (for example in a furnace duct), the porous structure can be placed within the airflow (for example disposed within the furnace duct) rather than within an airflow generated by an electro-kinetic air delivery system 120 or fan-based air delivery system 100.

The UV lamp 226 will generally be positioned such that the porous surface of the conditioning matrix 224 is substantially irradiated by UV light. The UV lamp 226 could be, for example, a Phillips model TUV 15W/Gi5 T8, a 15 W tubular lamp measuring about 25 mm in diameter by about 43 cm in length. Another suitable UV lamp 226 is the Phillips TUV 8WG8 T6, an 8 W lamp measuring about 15 mm in diameter by about 29 cm in length. It will be understood that other UV light sources that emit the desired wavelength can utilized because there are a myriad of different ways of introducing and activating the photocatalytic material arranged in the airflow.

Various types of catalysts can be used in a photocatalytic coating. For example, as described above the photocatalytic coating can be comprised of titania ceramic and of an alternative metal oxide, such as zinc oxide, cuprous oxide, silicon dioxide, etc. Oxides of manganese, copper, cobalt, chromium, iron and nickel are known to be active in oxidation reactions. Further, mixed oxides can be used for photocatalysis. For example, in some circumstances copper chromite (CuCrO₄) can be at least as active in promoting oxidation as cuprous oxide (CuO). These are just examples of coatings that can be used with embodiments of the present invention. Still further, noble metals can be effectively used to oxidize VOCs. For example, oxidation reactions on platinum and palladium are known to occur very rapidly.

In some embodiments, a noble metal can be impregnated or applied to a surface as a coating, for example with another substance (the amount of platinum and palladium is dependent on the level of VOCs present, but effectively a fraction of a percent relative to a total surface area on which it is applied). Oxidation of a VOC using a base metal photocatalytic coating may produce carbon monoxide (CO) as an oxidation byproduct. In one embodiment of the present invention, a noble metal, such as platinum or palladium, can be deposited, impregnated or otherwise applied to the base metal photocatalytic coating, or a surface or porous structure including the base metal photocatalyst.

The conditioning system 220 and the associated filter screens 222, 254 and conditioning matrixes 224 can be configured to remove and condition volatile organic compounds from the ambient air and the airflow path A-A. Alternatively, the conditioning system 220, or components of the conditioning system, can configured to remove or reduce excess ozone (O₃) contained within the ambient air and the airflow path A-A.

The conditioning matrix 224 and the filter screens 222, 254 can be configures as an ozone-reducing structure (ORS) to supplement or replace the photocatalytic or fine mesh screen matrices and filters discussed above. The ozone-reducing structure can be positioned at any location in the device that will provide for a reduction in the level of ozone that passes out of the air conditioning system. In one embodiment, the conditioning matrix 224 or ozone-reducing structure is positioned between the emitter array 122 and the collector array 124. Alternatively, the ozone reducing structure may be arranged adjacent to the air outlet 104 to condition the airflow A-A prior to leaving the housing 202, 230, and 260. Further, the conditioning system can be positioned in a separate housing positioned on the exterior of the device through which outlet air can pass.

It will be understood that the ozone reducing structure can in and around various elements of the electro-kinetic air delivery system 120 to reduce and control excess production of ozone. Alternatively, the ozone reducing structure can be integrated into the conditioning matrix 224 as shown in FIG. 2C to condition and remove the ozone present in the ambient air and the airflow A-A.

One alternate embodiment of the ozone reducing structures includes a grounding member that electrically connects the ORS or conditioning matrix 224 to the electrical ground of the system 200. In this way, the ORS or conditioning matrix 224 will not emit or contribute to the ionizing electric field generated by the electro-kinetic air delivery system 120. The grounded ORS or conditioning matrix 224 can create a voltage potential difference between the emitter electrodes 122 which causes the ambient air, the airflow A-A, and the ionized particles 114 suspended within in the air to flow toward the conditioning matrix 224. The conditioning matrix 224 thereby can collect the ionized particles suspended in the air that are not collected by the collector array 124 and also reduce or control excess ozone. However, it is possible that the ORS or conditioning matrix 224 could be coupled to the positive or negative terminals of the power source 126. If the ORS or conditioning matrix 224 is to be charged, it may be desirable provide a charge that is opposite of whatever charge is applied to the emitter electrodes 122 in order to promote air flow between the two elements.

The ORS or conditioning matrix 224 can be coated with a catalyst material selected to reduce or neutralize ozone in the ambient air and along the airflow path A-A. In one embodiment, the entire surface of the conditioning matrix 224 is coated with the catalyst, such that each opening or honeycomb cell 276 has catalyst material along its inner surfaces. Thus, as ozone passes through each cell 276, the catalyst substance converts the ozone into the oxygen and reduces the amount of ozone exiting conditioning matrix 224. A number of commercially available ozone reducing catalysts can be used, such as “PremAir” manufactured by Englehard Corporation of Iselin, N.J. Some ozone reducing catalysts, such as manganese chloride, manganese dioxide, are not electrically conductive, while others, such as activated carbon, are electrically conductive. Other examples of electrically conductive ozone reducing catalyst include, but are not limited to, noble metals.

FIG. 3 illustrates a perspective view of the housing 202 with the access panel 210 opened to reveal the interior of the tower portion 204. The housing 202 can be configured to support one or more of the air flow generators shown in FIGS. 1A and 1B. The housing can further support filters 222, 222′ positioned adjacent to the air inlet and outlet 104, 106, respectively. The interior of the tower portion 204, as revealed by the open access panel 210, supports the conditioning system 220. In this embodiment, the conditioning system 220 includes two conditioning matrices 224 and 224′ separated by the UV activator lamp 226.

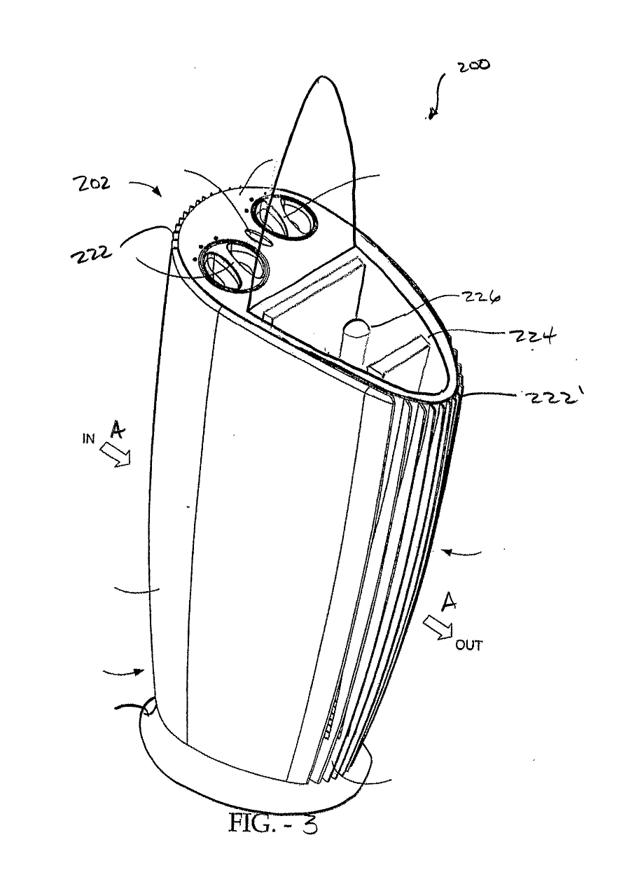

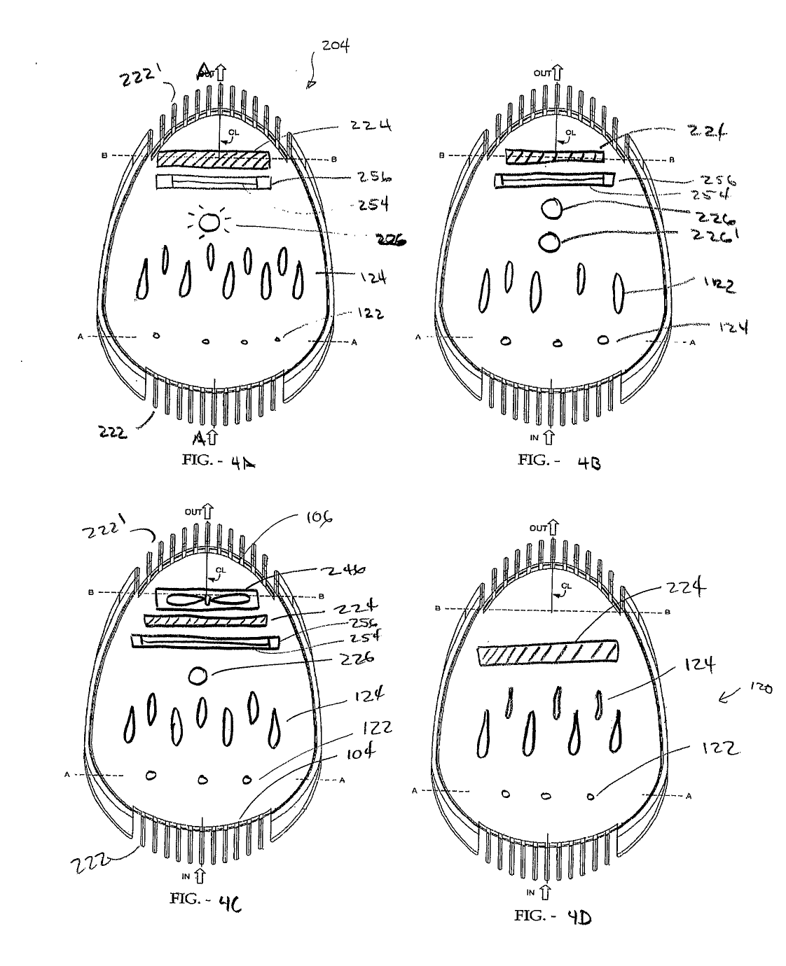

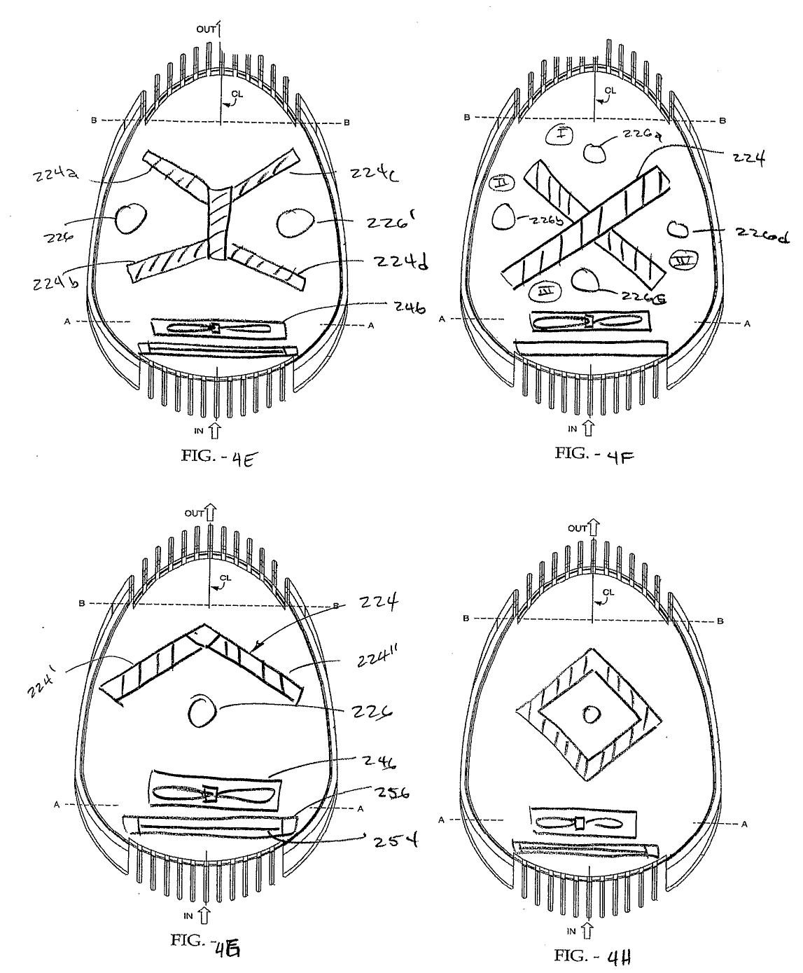

FIGS. 4A to 4H illustrates plan views of alternate configurations of the conditioning system 220 that may be incorporated into tower portion 204. It will be understood that these configurations are shown in the tower portion 204 as examples of how various embodiment of the air delivery and conditioning system 200 may be utilized. Furthermore, these configurations can be incorporated into any of the housing designs and shapes described and discussed above.

FIG. 4A illustrates one embodiment of the air delivery and conditioning system 200 and the conditioning system 220 arranged within the tower portion 204. The system 200 includes an electro-kinetic air delivery system 120 that includes the emitter array 122 and the collector array 124 arranged to generate an airflow as indicated by the arrows A-A. The conditioning system 220 includes the UV lamp 226 arranged between the system 120 and the wire mesh filter screen 254 and the conditioning matrix 224. FIG. 4B includes a second UV lamp 226′. The inclusion of the two UV lamps 226, 226′ provides for radiation sources that emit in two different spectrums and wavelengths. FIG. 4C illustrates a fan unit 246 arranged to boost and assist the airflow between the air inlet 104 and air outlet 106. The fan unit 246 increases the airflow along the airflow A-A. FIG. 4D illustrates a basic air delivery and conditioning system 200 that include the conditioning matrix 224 positioned adjacent to the electro-kinetic air delivery system 120.

FIGS. 4E to 4H illustrates exemplary embodiments of a fan-assisted air delivery and conditioning systems 200 that include at least one conditioning matrix 224. FIG. 4E illustrates a fan-assisted air delivery and conditioning system 200 having a pair of UV lamps 226, 226′ bracketed by a winged conditioning matrix 224. The winged conditioning matrix 224 includes arms 224a, 224b, 224c and 224d arranged to enclose the UV lamps 226, 226′, respectively. This configuration increase the surface area that can be activated by the UV lamps 226, 226′, thereby increasing the conditioning efficiency and output of the system 200. FIG. 4F illustrates a fan-assisted air delivery and conditioning system 200 including an X-shaped conditioning matrix 224. The divided sections (labeled I-IV) defined by the intersection of each leg of the conditioning matrix 224, brackets a plurality of UV lamps 226a to 226d to increase the activation surface area and the conditioning efficiency. FIG. 4F illustrates a fan-assisted air delivery and conditioning system 200 including a V-shaped conditioning matrix 224. The individual legs 224′, 224″ of the conditioning matrix 224 bracket the UV lamps 226. FIG. 4H illustrates a fan-assisted air delivery and conditioning systems 200 including a diamond shaped conditioning matrix 224 that encloses the UV lamp 226. Additional UV lamps could be included in to increase the activated surface area of the conditioning matrix 224.

The present disclosure generally relates to devices for removing ozone from air. In an embodiment, the device generally can include a support having an ozone reactive surface. The support can be mounted to a housing. The housing can be adapted to be placed in an air flow such that at least a portion of the air flow can flow through the support. As the air flows through the support, at least a portion of the air flows within reactive distance of the surface of the support such that the air contacts the reactive surface and a portion of the ozone from the air is removed. The housing can be mounted to any air flow device however, it is particularly useful for mounting to devices whose primary purpose is the movement of air, including electro-mechanical and electro-kinetic air movement devices.

Many suitable supports for the ozone reactive surface are known and can be used. Suitable supports include plastic and metal supports to which an ozone-reactive material can be incorporated or attached. The supports can be sufficiently porous to allow air flow without undue restriction. For example, the structure can be a honeycomb structure through which air can flow. The size of the holes or cells in the honeycomb of the support will depend upon the air flow device that is used with the device. For example, where air flow is generated by fans, the inside diameter of the holes can be smaller so long as the fans are powerful enough to maintain air flow through the support. However, when air flow is slower, such as when it is generated by certain electro-kinetic devices, the size of the openings in the structure will generally be larger to ensure that sufficient air flow can occur when the support is employed. It is well within the level of skill of one having skill in the art to select a porous structure having openings of a sufficient diameter to allow air flow in the resulting application.

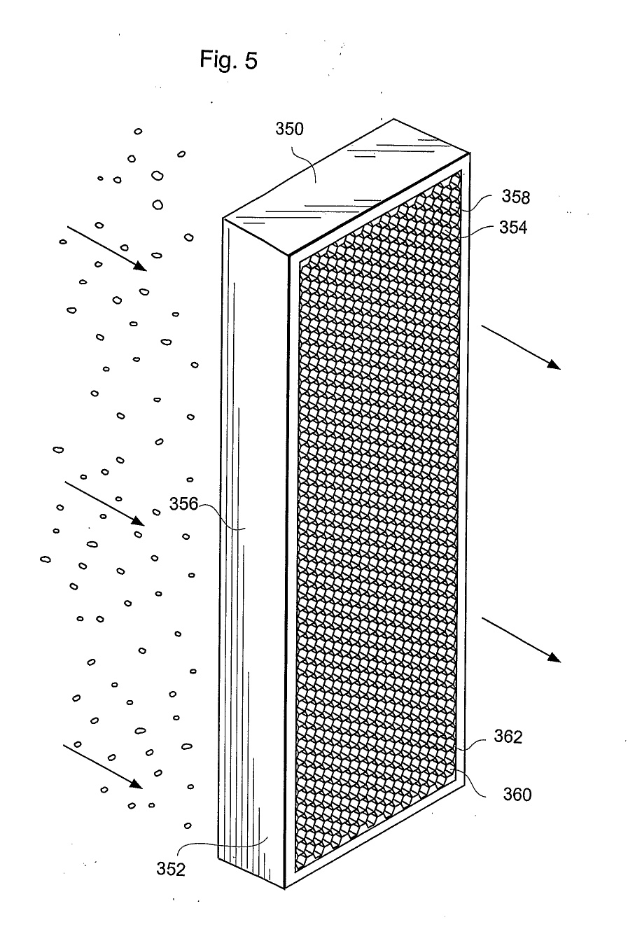

FIG. 5 illustrates a perspective view of the ozone-reducing substrate, ORS, 350 in accordance with one embodiment of the present invention. As shown in FIG. 5, ORS can include an outer frame 352 which can surround an inner grid 354. The grid includes an array of openings arranged in a pattern to form air passageways 360, referred to as cells, through the ORS 350. In an embodiment, the surfaces 362 are arranged to form multiple hexagonal air passageways, also termed generally as a “honeycomb” structure. It should be noted that the hexagonal shapes of the passageways 360 are but one example and the grid 354 is not intended to be limited to hexagonal shapes. For instance, the grid 354 can comprise circular, elliptical, square, rectangular, triangular or other polygonal-shaped air passageways or a combination of cell shapes, as desired. This grid structure 354 can also be referred to as a porous structure.

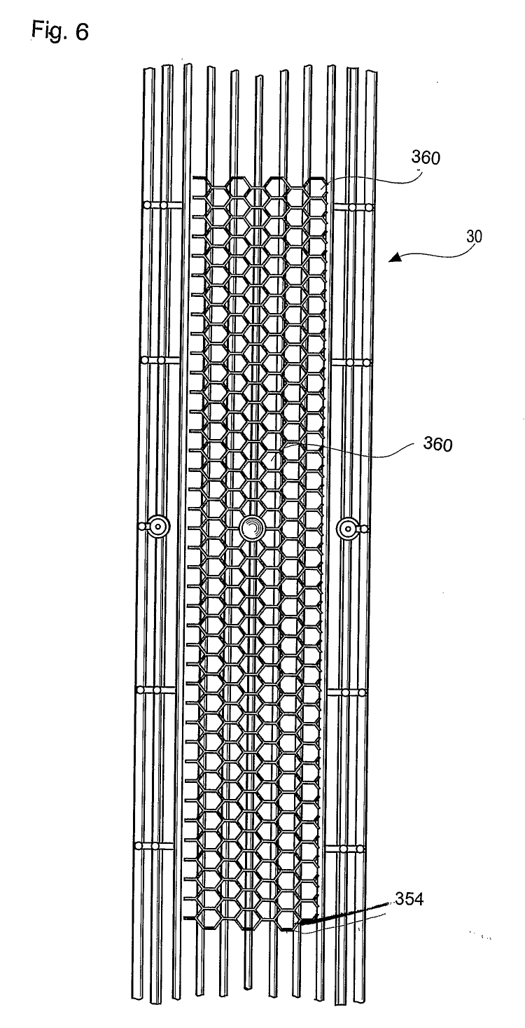

The surfaces 362 of the grid 354 are preferably made of a series of metal sheets which are attached to form the overall honeycomb shape, as illustrated in FIG. 6, of the air passageways 360. In one embodiment, the grid 354 is formed by stamping aluminum sheets and bonding them together to form the hexagonal air passageways. In certain embodiments, the metal sheets have uniform thicknesses and are polished to reduce surface drag along the air passageways. Thus, the surfaces 362 can be smooth and uniform. In certain embodiments, the edge of the surfaces 362 on the outlet side of the grid 354 can be sharp. This maybe advantageous for an embodiment in which the ORS 350 is electrically connected to a negative terminal of the voltage source, whereby negative or “feel good” ions are to be produced by the ORS 350 to be output by the device 100. Thus, the ORS 350 can be used to supplant or substitute the trailing electrodes in electro-kinetic air flow devices.

The grid 354 preferably has dimensions to allow the device 100 to maintain airflow velocity through the device. The surfaces 362 of the grid 354 have a width dimension which is designated as the distance from the inlet side 356 to the outlet side 358 of the grid 354. Additionally, each air passageway has a pitch dimension which is the distance between opposing parallel sides of the conductive surfaces 362. The width dimension and the pitch dimension of the grid 354 can be selected such that the highest airflow rate can be achieved. In particular, the pitch dimension is such to facilitate a sufficient airflow rate through the grid 354 with minimum airflow restriction. Additionally, the optimal pitch and width dimensions of each cell 360 provide a large surface area, when applied with a catalyst material, will significantly reduce the amount of ozone exiting the air flow device. In an embodiment, the pitch dimension of each air passageway 360 is approximately 0.125 to 0.25 inches, although other dimensions can be used.

The surfaces 362 are preferably coated with a catalyst material, whereby the catalyst material acts to reduce or neutralize ozone in the airflow without being chemically converted itself. Several methods for coating such surfaces are known in the art and can be used. The surfaces 362 of the support can be coated with an ozone-reducing agent or catalyst which can be a compound such as an oxide, for example a metal oxide, including silicon dioxide or manganese dioxide, for example. Some ozone reducing catalysts, such as manganese chloride, manganese dioxide, are not electrically conductive, while others, such as activated carbon, are electrically conductive. Other examples of electrically conductive ozone reducing catalyst include, but are not limited to, noble metals. As stated above, the optimal pitch and width dimensions of each cell 360 in the ORS 350 provide a large surface area upon which the catalyst material can be disposed. Preferably, the entire grid 354 is coated with the catalyst, whereby each cell 360 has catalyst material along its inner surfaces. As ozone passes through each cell 360 in the ORS 350, the catalyst substance on the conductive surfaces 362 converts the ozone into the oxygen, thereby reducing the amount of ozone exiting the ORS 350. The catalyst coated cells 360 in the grid 354 of the ORS 350 will thereby significantly reduce the amount of ozone exiting an air flow device. Several commercially available ozone reducing catalysts are known and can be used, including for example, “PremAir” manufactured by Englehard Corporation of Iselin, N.J.

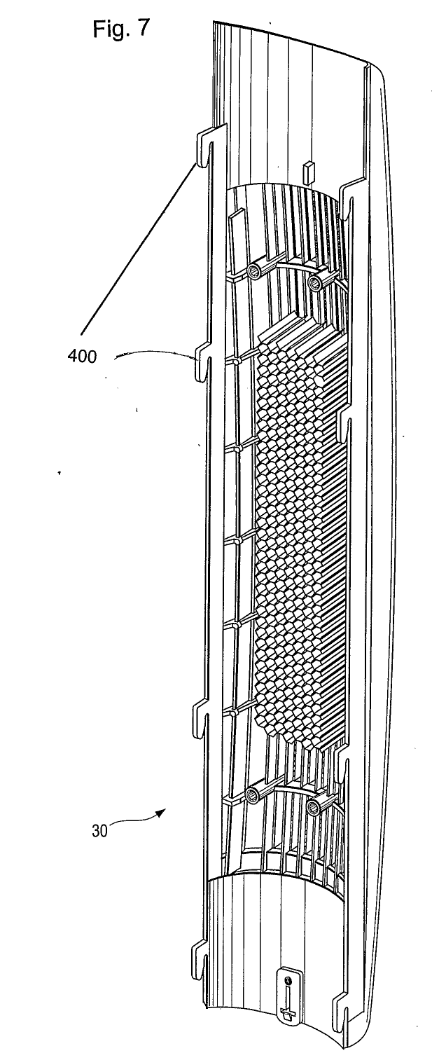

A number of methods for attaching the ozone reducing support structure to the housing are known and can be used. For example, the device shown in FIG. 5 can be conveniently inserted into and removed from a housing by mounting guide brackets in the housing and sliding the support into the housing the guide rails. Thus, the porous catalyst structure can be removable from the housing and can be easily replaced if it becomes damaged or worn out. The guide rails can be used to hold the support in a suitable position so that air flowing through the device will traverse the cells of the honeycomb structure. In an alternative embodiment, the ozone reducing structure can be glued directly into a housing. FIG. 7 illustrates an embodiment in which the support structure is glued into the housing a strong rubber cement. Alternatively, a portion of the housing can be heated and melted and the support melted into the housing. A wide variety of clips and fasteners can also be used to attach the support structure to a housing.

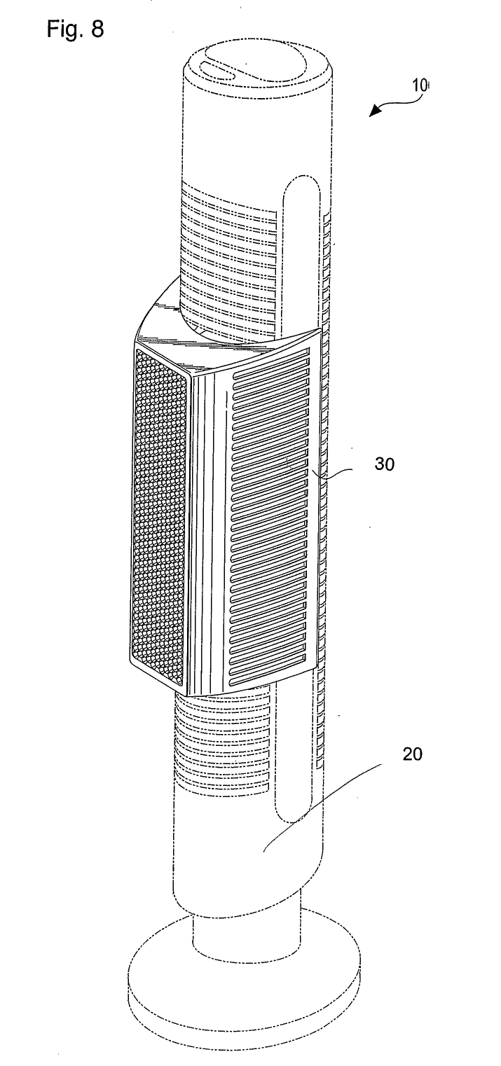

In an embodiment, the housing to which the ozone reducing support is attached can be a protective covering for the air movement device. Alternatively, the housing to which the ozone reducing support is attached can be adapted to attach to a protective covering for an air movement device. FIG. 8 illustrates such an embodiment in which an air movement device (10) has a protective covering (20) to which a housing (30) that supports an ozone reducing substrate is attached.

The present invention is particularly well suited for use with devices that move ambient air, as they are specifically designed for removing ozone from ambient air in order to purify air, including air in cars, homes, offices, airplanes and the like. As such, they can be used with electromechanical devices such as fans. For example, the ozone reducing devices can be mounted into a housing and placed in central air vents of homes, office buildings, automobiles, airplanes, or on window fans. The present disclosure contemplates that ozone reduction devices can be adapted for use with any fan.

The present disclosure also contemplates the use of ozone reduction devices with electro-kinetic air conditioner devices. In such devices, the ozone reduction supports can be mounted directly in protective grill coverings of such devices or they can be mounted in housings that are adapted to be mounted on such grill coverings.

In an embodiment, an air flow device is contemplated that contains a support having an ozone reactive surface mounted to a housing having an attachment means for positioning the housing in an air flow generated from the device such that a portion of the generated air flow can flow into the support and contact the reactive surface so as to remove a portion of the ozone from the air. The device further includes a device for generating an air flow that can be either an electro-kinetic air flow device or an electromechanical air flow device. For example, the electromechanical device for generating air flow can be a fan while an electro-kinetic air-flow device can be an Ionic Breeze®, such as is sold by Shaper Image Corp., San Francisco Calif.

Any housing that can hold the ozone reducing support securely and that does not restrict air flow is suitable for use in the present invention. The housing can be a protective cover for an air flow device or can be attachable to such a cover. The housing can be made of a hard plastic or metal or other material so long as the ozone reducing support can be held securely.

In housings that are adapted to be mounted to other protective coverings, any type of attachment method can be used, so long as the device can be securely mounted to the protective covering. For example, as illustrated in FIG. 7, hooks can be integrally incorporated onto the end of short arms on housing (30) such that the arm can be inserted into a protective grill covering and hook around the louvers of a grill. The weight of the housing will then hold such a housing to the protective grill covering. FIG. 8 illustrates another embodiment of the housing. Housings can also be mounted with nuts and bolts, screws, adhesives, straps, adhesive tape and the like.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An air delivery and conditioning system comprising:
a housing defining an air inlet fluidly connected to an air outlet;
at least one airflow generator carried within the housing and adapted to create an airflow in a path;
a conditioning matrix positioned within the airflow path; and
a catalytic material applied to the conditioning matrix for catalyzing the reaction of pollutants so as to reduce their concentration.

2. The system of claim 1, wherein the conditioning matrix is a volatile organic compound conditioning matrix.

3. The system of claim 1, further comprising a light for activating the catalytic surface of the conditioning matrix.

4. The system of claim 1, wherein the airflow generator is a fan-based air delivery system.

5. The system of claim 1, wherein the at least one airflow generator is an electro-kinetic air delivery system.

6. The system of claim 1, wherein the conditioning matrix is a honeycombed matrix.

7. The system of claim 1, wherein reactive material is a titanium dioxide adapted to react with ozone within the airflow.

8. The system of claim 1 further comprising a radiation source arranged to emit radiation onto a surface of the conditioning matrix.

9. The system of claim 1, wherein reactive material is selected from the group consisting of titanium dioxide, cuprous oxide, zinc oxide, silicon dioxide and oxides including manganese, copper, cobalt, chromium, iron, titanium, zinc and nickel.

10. The system of claim 1, wherein the conditioning matrix includes an ozone conditioning matrix and a volatile organic compound conditioning matrix.

11. A composition for removing ozone from air comprising: a support having an ozone reactive surface mounted to a housing having an attachment mechanism for positioning the housing in an air flow of an air-flow device such that a portion of the air flow through the device passes through the support and contacts the reactive surface so as to remove a portion of the ozone from the air-flow

12. The composition for removing ozone from air of claim 11 wherein the air-flow device comprises an electro-kinetic device.

13. The composition for removing ozone from air of claim 11 wherein the air-flow device comprises an electromechanical device.

14. The composition for removing ozone from air of claim 11 wherein the housing comprises a protective covering for the air movement device.

15. The composition for removing ozone from air of claim 11 wherein the housing is adapted to attach to a protective covering for the air movement device.

16. The composition for removing ozone from air of claim 11 wherein a portion of the support is coated with a compound capable of catalyzing the reduction of ozone.

17. The composition for removing ozone from air of claim 11, wherein a portion of the support is coated with a compound capable of catalyzing the reduction of ozone, the compound comprising an oxide.

18. The composition for removing ozone from air of claim 11, wherein a portion of the support is coated with a compound capable of catalyzing the reduction of ozone, the compound comprising a metal oxide.

19. The composition for removing ozone from air of claim 11, wherein a portion of the support is coated with a compound capable of catalyzing the reduction of ozone, the compound comprising an oxide of manganese.

20. The composition for removing ozone from air of claim 11, wherein the porous catalyst structure is removable from the housing.
